(19) United States
(12) Patent Application Publication
(10) Pub. No.: US 2008/0082846 A1
(43) Pub. Date: Apr. 3, 2008

(54) INFORMATION PROCESSING APPARATUS AND ITS CONTROL METHOD

(75) Inventors: Kazuhiro Yoshioka, Akishima-shi (JP); Toshikazu Morisawa, Tokorozawa-shi (JP)

Correspondence Address: KNOBBE MARTENS OLSON & BEAR LLP, 2040 MAIN STREET, FOURTEENTH FLOOR, IRVINE, CA, 92614, US

(73) Assignee: Kabushiki Kaisha Toshiba, Tokyo (JP)

(21) Appl. No.: 11/864,585

(22) Filed: Sep. 28, 2007

(30) Foreign Application Priority Data
Sep. 29, 2006 (JP) 2006-268260

(51) Int. Cl. G06F 15/177; G06F 1/32

(52) U.S. Cl. 713/323; 713/2

(57) ABSTRACT

According to one embodiment, an information processing apparatus includes a main memory storing a operating state of a system, a drive apparatus including a magnetic disk and a non-volatile memory, a storing section which stores the operating state stored in the main memory in the non-volatile memory, a setting section which sets the system to a sleeping state, a judgment section which determines whether or not the operating state is stored in the non-volatile memory in response to a generation of a wakeup event, and a return section which returns the system from the sleeping state, when it is determined that the operating state is stored, and gives no instructions to rotate the magnetic disk of the drive apparatus.

### CROSS-REFERENCE TO RELATED APPLICATIONS

This application is based upon and claims the benefit of priority from Japanese Patent Application No. 2006-268260, filed Sep. 29, 2006, the entire contents of which are incorporated herein by reference.

### BACKGROUND

1. Field

One embodiment of the present invention relates to an information processing apparatus such as a personal computer, which can make a system state transition between a working state and a sleeping state, and to its control method.

2. Description of the Related Art

In order to reduce computer power consumption, the following operation is made. Namely, in a state that a operating state of a main memory is held, or stored in a hard disk drive, at least part of the power supply to a system device is cut. This state calls a sleeping state.

Jpn. Pat. Appln. KOKAI Publication No. 2003-85041 discloses the following technique. According to the technique, a operating state of a main memory in a operating state is stored in a non-volatile memory to rapidly shift a state from a sleeping state to a working state. When the state returns to the operating state, the operating state stored in the non-volatile memory is used.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is an exemplary perspective view showing the appearance of an information processing apparatus according to a first embodiment;

FIG. 2 is an exemplary block diagram showing the system configuration of the information processing apparatus according to the first embodiment;

FIG. 3 is an exemplary flowchart showing a power-on self-test (POST) procedure according to a first embodiment;

FIG. 4 is an exemplary block diagram showing the system configuration of an information processing apparatus according to a second embodiment;

FIG. 5 is an exemplary flowchart showing a transition procedure from a system working state to a system non-working state such as a hybrid sleep;

FIG. 6 is an exemplary table showing a system end operation and a sleeping state stored in a CMOS memory; and

FIG. 7 is an exemplary flowchart showing a power-on self-test (POST) procedure according to a second embodiment.

### DETAILED DESCRIPTION

Various embodiments according to the invention will be described hereinafter with reference to the accompanying drawings. In general, according to one embodiment of the invention, an information processing apparatus comprises a main memory storing a operating state of a system, a drive apparatus including a magnetic disk and a non-volatile memory, a storing section which stores the operating state stored in the main memory in the non-volatile memory, a setting section which sets the system to a sleeping state, a judgment section which determines whether or not the operating state is stored in the non-volatile memory in response to a generation of a wakeup event, and a return section which returns the system from the sleeping state, when it is determined that the operating state is stored, and gives no instructions to rotate the magnetic disk of the drive apparatus.

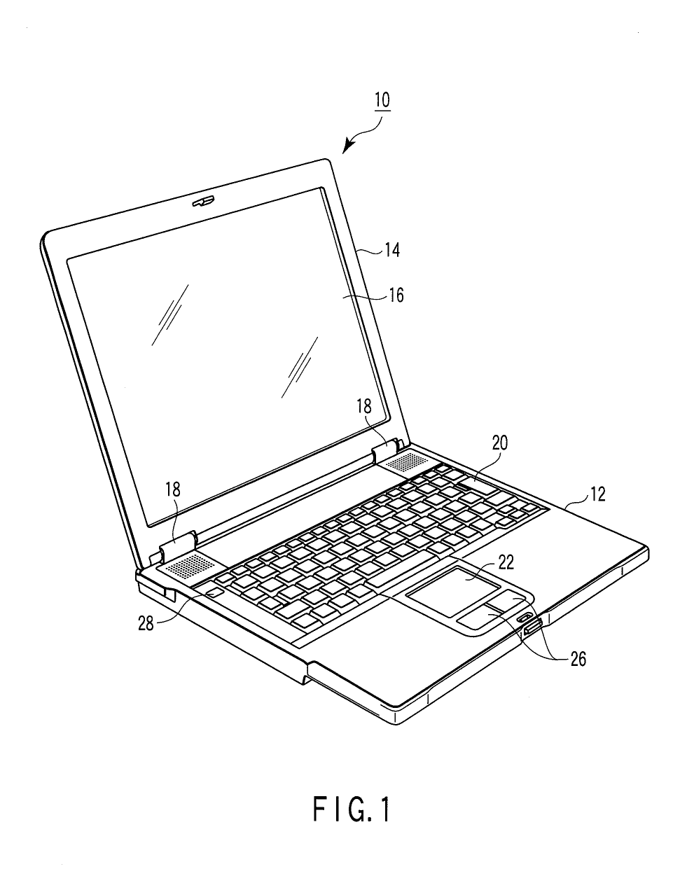

FIG. 1 is a perspective view showing the appearance of a notebook-type personal computer given as an information processing apparatus according to one embodiment of the present invention.

A personal computer 10 is composed of a computer body 12 and a display unit 14. The display unit 14 has a built-in liquid crystal display (LCD) 16.

The display unit 14 is attached to a hinge (support portion) 18 provided to the depth side end of the computer body 12 so that it is freely rotatable between an opening position and a closed position. The opening position is a position where an upper surface of the computer body 12 is exposed. The closed position is a position where the upper surface of the computer body 12 is covered with the display unit 14.

The computer body 12 has a thin box-like case. The center of the upper surface of the case is provided with a keyboard 20. The upper surface of the case at the front side of the computer body 12 is formed with a palm rest. The center of the palm rest is provided with a touch pad 22 given as operating means and a touch pad control button 26. The upper surface of the case at the depth left side of the computer body 12 is provided with a power button 28 for turning on/off the power of the computer body 12.

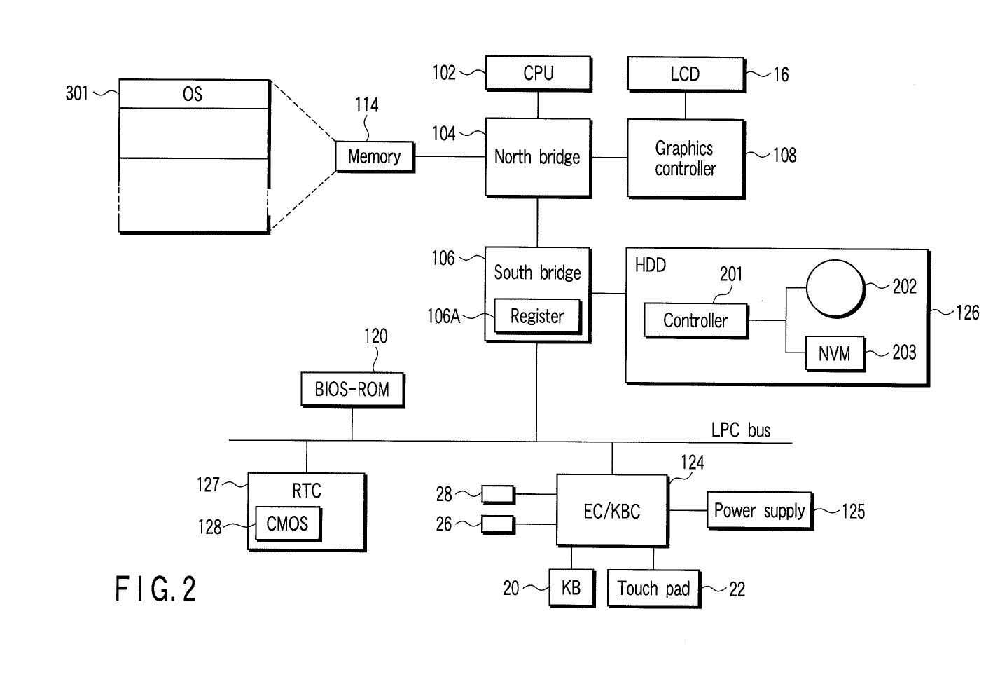

The system configuration of the computer will be hereinafter described with reference to FIG. 2.

As shown in FIG. 2, the computer includes a CPU 102, a north bridge 104, a main memory 114, a graphics controller 108, a south bridge 106, a BIOS-ROM 120, and a hard disk drive (HDD) 126. Further, the computer includes an embedded controller/keyboard controller IC (EC/KBC) 124, a power supply 125, a real-time clock (RTC) 127 and a CMOS memory 128.

The HDD 126 includes a controller 201, a magnetic disk 202 and a non-volatile memory (NVM) 203. The non-volatile memory 203 comprises a NAND-type flash EEPROM. The controller 201 selectively makes an access to the magnetic disk 202 and the non-volatile memory 203.

In the HDD 126, the non-volatile memory 203 is used as a cache memory with respect to the magnetic disk 202. By doing so, information write and read speed is improved, and the number of accesses of the hard disk, that is, the number of information write and read times to the hard disk is reduced. As a result, power consumption of a battery is reduced.

The CPU 102 is a processor provided for controlling an operation of the computer. The CPU 102 executes various application programs including an operating system (OS) 301, loaded from the hard disk drive (HDD) 126 to the main memory 114.

The CPU 102 loads a system Basic Input-Output System (BIOS) stored in the BIOS-ROM 120 to the main memory 114, and thereafter, executes it. The system BIOS is a program for controlling hardware.

The north bridge 104 is a bridge device for making a connection between a local bus of the CPU 102 and the south bridge 106. The north bridge 104 has a function of making communications with the graphics controller 108 via an accelerated graphics port (AGP).

The graphics controller 108 is a display controller for controlling the LCD 16 used as a display monitor of the computer. The graphics controller 108 has a video memory (VRAM). The graphics controller 108 generates a video signal forming a display image to be displayed on the LCD 16 from display data written in the video memory via an OS/application program. The video signal generated by the graphics controller 108 is outputted to a line.

The south bridge 106 is connected to each of a Peripheral Component Interconnect (PCI) bus and a low pin count (LPC) bus.

The embedded controller/keyboard controller IC 124 controls the touch pad 22 used as input means and the touch pad control button 26. The embedded controller/keyboard controller IC 124 is a one-chip microcomputer, which monitors and controls various devices (peripheral device, sensor, power circuit) regardless of a system state of the computer 10.

The shift procedure from hibernation state to a system working state according to this embodiment will be explained below. The hibernation state calls a state that system information (including a operating state on memory) for restoring the previous system operating environment of the computer 10 (calling context) is stored in the hard disk drive 126. The hibernation state is a low power consumption state of turning off the power of all devices including the main memory 114. In the hibernation state, if a wakeup event generates, the system state returns from the sleeping state to the working state using the system information stored in the hard disk drive 126. Then, a work is restarted from the state just before being shifted to the hibernation state. For example, the hibernation state is equivalent to S4 conforming to the Advanced Configuration and Power Interface (ACPI) specification. The foregoing hibernation state and a suspend state are specified as a sleeping state. The suspend state is equivalent to S3 conforming to the ACPI specification.

Specifically, according to the ACPI specification, system states from S0 to S5 are defined. A system state S0 is a working state (i.e., the system is powered on, and software is executed. A system state S5 is an off state (i.e., the system is powered off, and no software is executed. System states S1 to S4 are intermediate states between the working state and the off state, that is, a sleeping state (software context just before being shifted to the sleeping state is saved, and the software is stopped in the sleeping state). The relationship of the power consumption of these system states is S0>S1>S2>S3>S4>S5.

The system state (S0 to S5) is stored in a register 106A of the south bridge, for example.

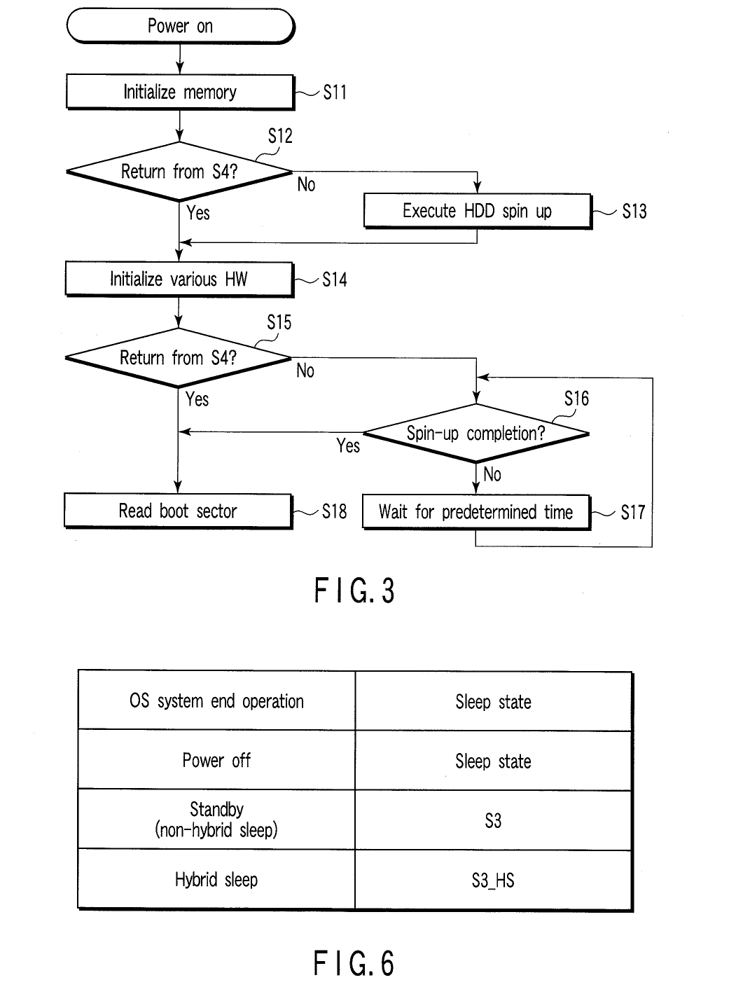

When a wakeup event generates by pressing the power button 28 by user, the CPU 102 executes a POST (power-on self-test) procedure according to BIOS stored in the BIOS-ROM 120. The POST procedure will be described with reference to a flowchart of FIG. 3.

The BIOS initializes the memory 114 (step S11). Initialization of the memory 114 normally ends. Thereafter, the BIOS refers to the register 106A of the south bridge 106 to determine whether or not boot is made by return from sleeping state S4 (hibernation) (step S12). If it is determined boot is made by return from sleeping state S4, the BIOS issues no command for instructing spin-up of the magnetic disk 202.

If the boot is not made by return from sleeping state S4 (No in step S12), the BIOS issues a command for instructing spin-up of the magnetic disk 202 to the HDD 126 (step S13).

The BIOS initializes various hardware (HW) so that a boot sector transferring the control to the OS becomes a state of being readable from the HDD 126 (step S14).

If return from sleeping state S4 is not given (No in step S15), the CPU 102 waits for HDD 126 spin-up completion (steps S16, S17). If the boot is not made by return from sleeping state S4 (Yes in step S15) or spin-up is completed (Yes in step S16), the CPU 102 reads the boot sector from the HDD 126 (step S18), and then, executes the boot sector. According to a procedure described in the boot sector, the control is shifted from the BIOS program to the OS 401.

If return from sleeping state S4 is made, the boot sector is stored in the non-volatile memory 203 of the HDD 126. Therefore, the system is restored without spinning up the magnetic disk 202. In this way, according OS boot by return from sleeping state S4, the OS 401 boots in a state that the magnetic disk 202 of the HDD 126 is stopped.

Inherently, an HDD spindle stopped state is maintained during return period where spin-up of the magnetic disk 202 is unnecessary. Thus, power consumption of the information processing apparatus is reduced.

The OS operates, and thereafter, a period where access to the magnetic disk 202 is unnecessary is continued. By doing so, the system is continuously used in a spindle stopped state of the magnetic disk 202. Thus, return from sleeping state S4 is given and thereafter, power consumption of the information processing apparatus is reduced. Heat generated from the HDD 126 is restricted during a spindle stopped state of the magnetic disk 202. This serves to obtain the following advantages. Specifically, the information processing apparatus is operated at a low temperature, and rotation of cooling fan is restricted, and thus, power consumption is reduced.

Even if the computer body receives impact when returns from sleeping state S4, the magnetic disk 202 is in a stopped state. Therefore, this serves to eliminate a possibility that the disk surface of the magnetic disk 202 receives damages by contact with a head swing arm. Moreover, the return operation from sleeping state S4 prevents the HDD from receiving damage.

### SECOND EMBODIMENT

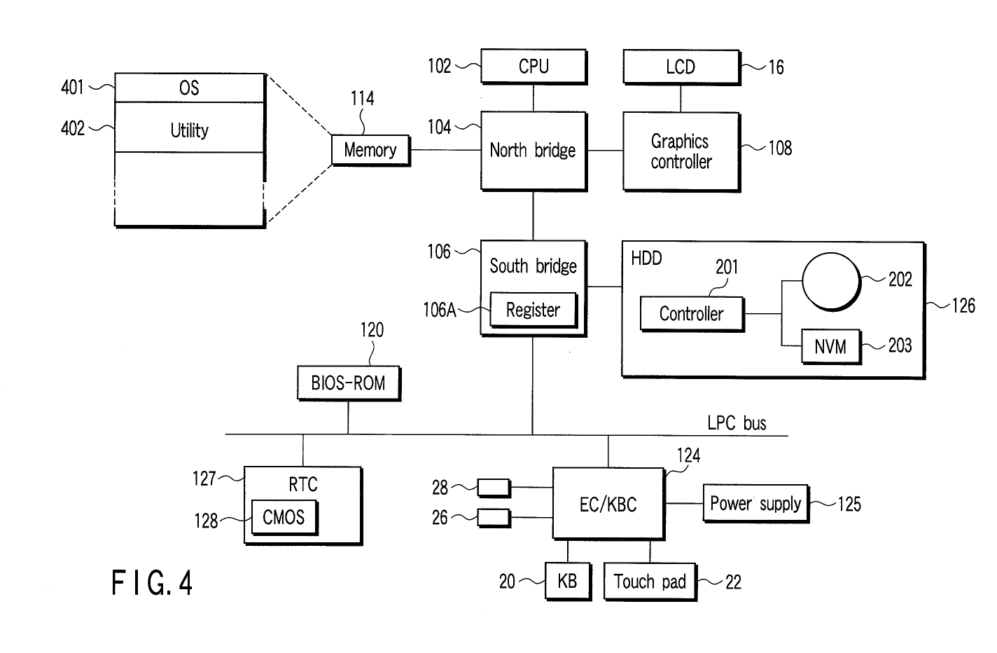

The system configuration of a computer will be hereinafter described with reference to FIG. 4.

As shown in FIG. 4, the computer includes a CPU 102, a north bridge 104, a main memory 114, a graphics controller 108, a south bridge 106, a BIOS-ROM 120, and a hard disk drive (HDD) 126. The computer further includes an embedded controller/keyboard controller IC (EC/KBC) 124, a power supply 125, a real-time clock (RTC) 127 and a CMOS memory 128.

The CPU 102 is a processor provided for controlling an operation of the computer. The CPU 102 executes various application programs including an operating system (OS) 401 and utility 402, loaded from the hard disk drive (HDD) 126 to the main memory 114. The utility 402 monitors the operating system (OS) 401, that is, the operation thereof to detect shift to a sleeping state of the system and an operation end state including software off.

The real-time clock (RTC) 127 is always supplied with power from a dedicated battery of the real-time clock (RTC) 127 or the power supply 125. The real-time clock 127 is a count module (timer) counting date and time. Moreover, the real-time clock (RTC) 127 has a function of generating an alarm signal when time designated by the CPU 102 elapses, or the current date and time comes to the date and time designated by the CPU 102.

The CMOS memory 128 records normal hardware configuration information in a general memory area existing in the RTC 127. Even if the system is in a non-working state, the CMOS memory 128 exists in the RTC 127; therefore, it is always supplied with power. Thus, the recording contents are held.

The operating system (OS) 401 of the computer has a hybrid sleep function. The hybrid sleeping means the following sleep operation. The state is shifted to a suspend state (hereinafter, referred to as sleeping state S3) resuming from a operating state just before stored in the memory 114. In this case, the operating system shifts to sleeping state S3 in a state of writing the content of the memory to the hard disk to save the operating state.

According to the hybrid sleep, when sleeping state S3 is continued for a predetermined time, the system once returns to boot the operating system (OS) 401, and again shifts to a hibernation state (hereinafter, referred to as sleeping state S4). The operating system 401 creates data required for return from sleeping state S4 when shifting to sleeping state S3. Therefore, the OS 401 can immediately shift from sleeping state S3 to sleeping state S4.

After predetermined time elapses, in order to shift the information processing apparatus from sleeping state S3 to sleeping state S4, the OS 401 sets a wakeup time to the RTC 127 before the system sleeps in the hybrid sleep. By doing so, predetermined time elapses during sleeping state S3, and thereafter, the OS can shift to sleeping state S4.

The foregoing hybrid sleep is used, and thereby, the information processing apparatus is shifted to sleeping state S4 having no power consumption without user's operation before the remaining amount of battery is used up in a battery power. By doing so, it is possible to prevent a possibility that return information lost incapable of performing resume return by the used up of the battery.

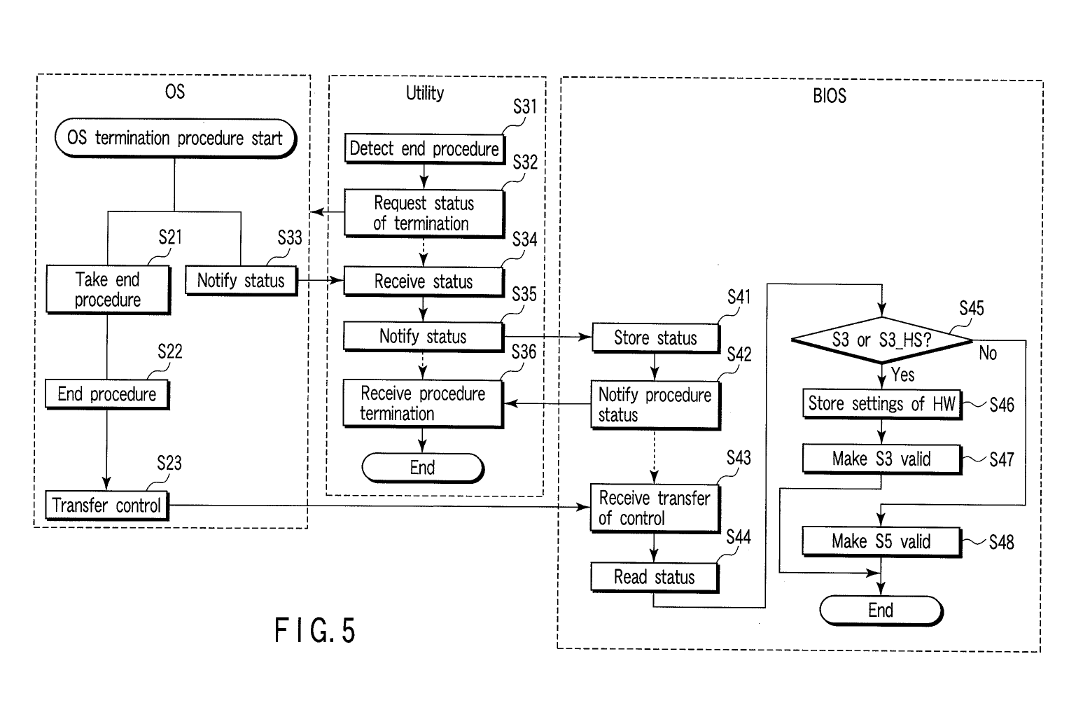

The shift from a system working state to a system on-working state such as the hybrid sleep will be hereinafter described with reference to FIG. 5. When user gives instructions to end the operating system by sleep and shut down in the hybrid sleep, the operating system starts an end procedure.

The utility 402 monitors the operation of the operating system (OS) 401, and detects a shift to a system end working state (step S31). The utility 402 request a kind of the system end operation with respect to the operating system (OS) 401 (step S32).

The operating system (OS) 401 notifies the kind of the end operation with respect to the request from the utility 402 (step S33). The utility 402 receives the kind of the end operation (step S34). If the kind received from the operating system (OS) 401 is the hybrid sleep, the utility 402 receives time for shifting to sleeping state S4 from the operating system (OS) 401.

Then, the utility 402 notifies the kind of the end operation with respect to the BIOS (step S35). If the kind is a sleeping state, the utility 402 notifies time for shifting to sleeping state S4 with respect to the BIOS.

The BIOS stores the sleeping state in a storage holding the content even if the system such as CMOS memory 128 ends (step S41). FIG. 6 shows system end operations, and sleeping states stored in the CMOS memory 128 by the BIOS.

The BIOS notifies a storing procedure end with respect to the utility 402 (step S42). When receiving the storing procedure notification (step S36), the utility 402 ends the procedure.

On the other hand, the operating system (OS) 401 executes a system end procedure (step S21). If user gives instructions to designate an information processing apparatus off operation in the hybrid sleep, the operating system (OS) 401 creates hibernation data required for a hibernation return operation, and stores it in the non-volatile memory 203. The operating system (OS) 401 sets time for an exchange from sleeping state S3 to sleeping state S4 to the real-time clock (RTC) 127 using the hybrid sleep function. The time is previously designated by user.

When the system end procedure ends (step S22), the operating system (OS) 401 transfers the control to the BIOS (step S23). When receiving the transfer of the control (step S43), the BIOS reads a status stored in step S41 from the CMOS memory 128 (step S44).

The BIOS determines whether or not the read state is state S3 or S3_HS (step S45). If the BIOS determines that the read state is state S3 or S3_HS Yes in step S45), hardware (HW) settings are stored in an area usable by the BIOS of the memory 114 (step S46). In a sleep such as state S3 or S3_HS, the content of the memory 114 is electrically held. Register S3 of register 106A of the south bridge 106 is made valid (step S47), the procedure ends.

In step S45, if the BIOS determines that the read state is not state S3 or S3_HS (No in step S45), the BIOS makes valid a S5 register of the register 106a of the south bridge (step S48), and then, ends the procedure.

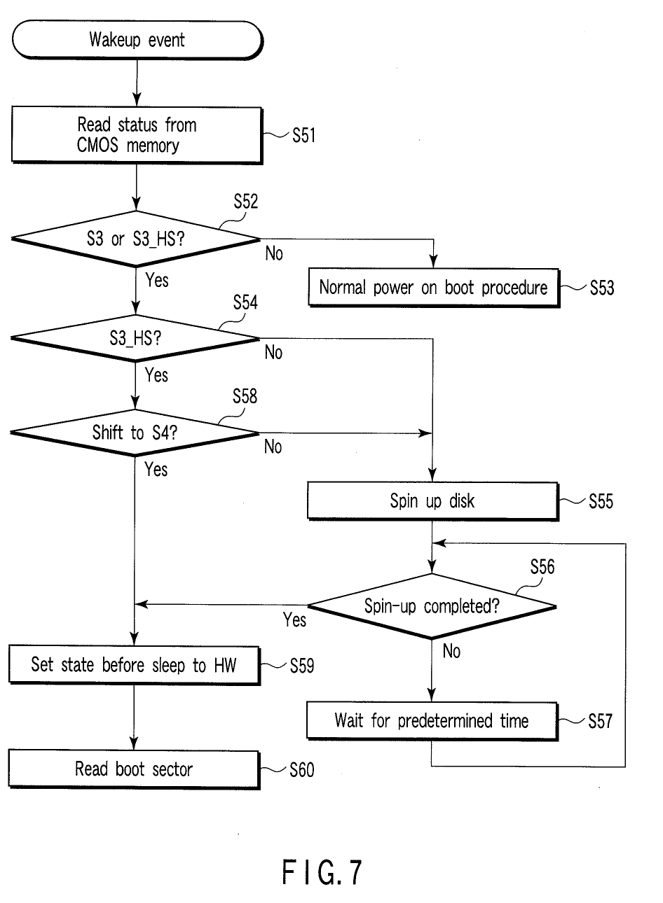

The operation when a wakeup event giving instructions to boot the system, such as operation of power button 28 by user, alarm signal from the RTC 127 generates will be hereinafter described with reference to FIG. 7.

The BIOS reads a status stored in the CMOS memory 128 (step S51). The BIOS determines whether or not the read status is state S3 or S3_HS (step S52). If the read status is not state S3 or S3_HS, the BIOS executes a normal boot procedure (step S53).

If it is determined that the read status is a S3 or S3_HS (Yes in step S52), the BIOS determines whether or not the read status is S3_HS (step S54).

If it is determined that the status is S3_HS (Yes in step S54), the BIOS determines whether or not a wakeup event generates for a shift to sleeping state S4 (step S58). In the hybrid sleep, the CMOS memory 128 is stored with time for shifting from the hybrid sleep to sleeping state S4. The BIOS compares the shift time stored in the CMOS memory 128 with time where the wakeup event generates, and thereby, determines whether or not a wakeup event for shifting to sleeping state S4 generates.

If it is determined that the status is not S3_HS (No in step S54), or it is determined that the wakeup event is not generated for shift to sleeping state S4 (No instep 54), the BIOS issues a command for instructing spin-up of the magnetic disk 202 to the HDD 126 (step S55). The BIOS determines whether or not spin-up of the magnetic disk 202 is completed (step S56, step S57).

If it is determined that the wakeup event is for shift to sleeping state S4 (Yes in step S58), or it is determined that spin-up is completed (Yes in step S56), the BIOS sets hardware (step S59). In this case, the BIOS sets hardware based on settings of various hardware stored in an area usable by the BIOS of the memory 114. The BIOS reads a boot sector from the HDD 126 (step S60), and thereafter, transfers the control to the operating system.

In this case, If the status is S3_HS (hybrid sleep) in step S54, the boot sector is read from the non-volatile memory 203. The system returns from the hybrid sleep (S3_HS) only executes the shift control to sleeping state S4 immediately. For this reason, the operating system (OS) 401 makes no access to data stored in the magnetic disk 202 of the HDD 126 in particular. Thus, there is no need of spinning up the magnetic disk 202. Inherently, a HDD spindle stopped state is maintained during a return period by the OS having no need of spinning up the magnetic disk 202. As a result, power consumption of the information processing apparatus is reduced.

In the shift to sleeping state S3 and the hybrid sleep, sleeping state S3 is set to the register 106A. In other words, the BIOS cannot determine whether the status is sleeping state S3 or the hybrid sleep even if referring to the register 106A.

According to this embodiment, the utility notifies the kind with respect to the BIOS, and then, writes it to the CMOS memory 128. Therefore, the BIOS can determine whether the status is sleeping state S3 or the hybrid sleep. The generation time of the wakeup event is stored in the CMOS 128; therefore, it is determined whether or not the system boots for a shift to sleeping state S4.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the invention.

What is claimed is:

1. An information processing apparatus comprising:
a main memory configured to store a system operating state;
a drive apparatus comprising a magnetic disk and a non-volatile memory;
a storing section configured to store a copy of the system operating state in the non-volatile memory;
a setting section configured to set the information processing apparatus to a sleeping state;
a judgment section configured to determine, in response to a wakeup event, whether the system operating state is stored in the non-volatile memory; and
a return section configured to return the system from the sleeping state without giving instructions to rotate the magnetic disk when it is determined that the system operating state is stored in the non-volatile memory.

2. The apparatus according to claim 1, wherein the judgment section comprises a basic input output system (BIOS).

3. The apparatus according to claim 1, wherein the sleeping state comprises a hibernation state in which the system operating state is not retained in the main memory, the information processing apparatus further comprises a register configured to store information corresponding to whether the information processing apparatus is in the hibernation state, the judgment section is configured to refer to the register in order to determine whether the system operating state is stored, and wherein the return section is configured to return the information processing apparatus from the sleeping state based on the system operating state stored in the non-volatile memory.

4. The apparatus according to claim 1, wherein the sleeping state comprises a hybrid sleep state and the storing section is configured to store a copy of the data stored by the main memory in the non-volatile memory before the information processing apparatus is set to the sleeping state, the information processing apparatus further comprising:
a storage configured to store information indicating whether the sleeping state comprises the hybrid sleep state;
a wakeup section configured to set a time of the wakeup event, and configured to generate the wakeup event in response to the set time; and
a hibernation setting section configured to set the system to a hibernation state in which the system operating state is not retained in the main memory;
wherein the judgment section is configured to refer to the storage to determine whether or not the system operating state is stored.

5. The apparatus according to claim 3, wherein the storage is a non-volatile memory or a memory supplied with power from a battery for holding a recording content.

6. A control method for an information processing apparatus comprising a main memory configured to store a system operating state and comprising a drive apparatus including a magnetic disk and a non-volatile memory, the method comprising:
storing a copy of the system operating state stored in the main memory to the non-volatile memory;
setting the information processing apparatus to a sleep state;
determining whether or not the system operating state is stored in the non-volatile memory in response to a generation of a wakeup event; and
returning the system from the sleep state by writing the system operating state stored in the non-volatile memory to the main memory without giving instructions to rotate the magnetic disk, when it is determined that the operating state is stored in the non-volatile memory

7. The method according to claim 6, wherein the determination is made by a basic input output system (BIOS).

8. The method according to claim 6, wherein the sleep state comprises a pause state in which the system operating state is not retained in the main memory, the information processing apparatus further comprises a register storing information indicating whether the information processing apparatus is set to the pause state, and wherein the step of determining whether the system operating state is stored is made by referring to the register.

9. The method according to claim 6, wherein the sleep state is a hybrid sleep state and wherein data stored in the main memory is stored to the non-volatile memory before the information processing apparatus is set to the sleep state, the method further comprising:
storing information indicating whether the sleep state is the hybrid sleep state before the information processing apparatus is set to the hybrid sleep state;
setting a generation time of the wakeup event when the information processing apparatus is set to the hybrid sleep;
generating the wakeup event at the set time; and
setting the main memory to a pause state in which the system operating state is not stored in the main memory after the system returns from the sleep state;
wherein the step of determining whether or not the system operating state is stored in the non-volatile memory is made by referring to the storage, and wherein the step of returning the system from the sleep state is carried out based on the system operating state.

10. The method according to claim 9, wherein the storage comprises at least one of a non-volatile memory or a memory supplied with power from a battery.
